(19) United States
(12) Patent Application Publication
(10) Pub. No.: US 2010/0097397 A1
(43) Pub. Date: Apr. 22, 2010

(54) ELECTRONIC DEVICE AND PHOTOS MERGING METHOD THEREOF

(75) Inventor: TZU-HAO HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/541,366

(22) Filed: Aug. 14, 2009

(30) Foreign Application Priority Data
Oct. 20, 2008 (CN) 200810305020.4

(51) Int. Cl. G09G 5/00

(52) U.S. Cl. 345/629

(57) ABSTRACT

An electronic device and a method for merging photos to obtain a merged photo using an electronic device captures at least one portrait photo using a camera module of the electronic device and edits the at least one portrait photo to obtain at least one cropped photo. The electronic device and the method for merges the selected cropped photo with the captured scenic photo to obtain a merged photo.

### BACKGROUND

1. Technical Field

Embodiments of the present disclosure are related to photos processing, and particularly to an electronic device and a method for merging photos together.

2. Description of Related Art

Users can use electronic devices to listen to music, take photos, and browse webpages, for example. After taking photos, the users often store the photos freely in the electronic devices. However, manipulation and editing of the photos may be limited and cumbersome.

What is needed, therefore, is an improved electronic device and method for merging photos to overcome the above-stated problems.

### BRIEF DESCRIPTION OF THE DRAWINGS

FIG. 1 is a block diagram of one embodiment of an electronic device.

FIG. 2 is a flowchart of one embodiment of a method for merging photos using the electronic device of FIG. 1.

FIGS. 3-6 are schematic diagrams of merging photos using the electronic device of FIG. 1.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

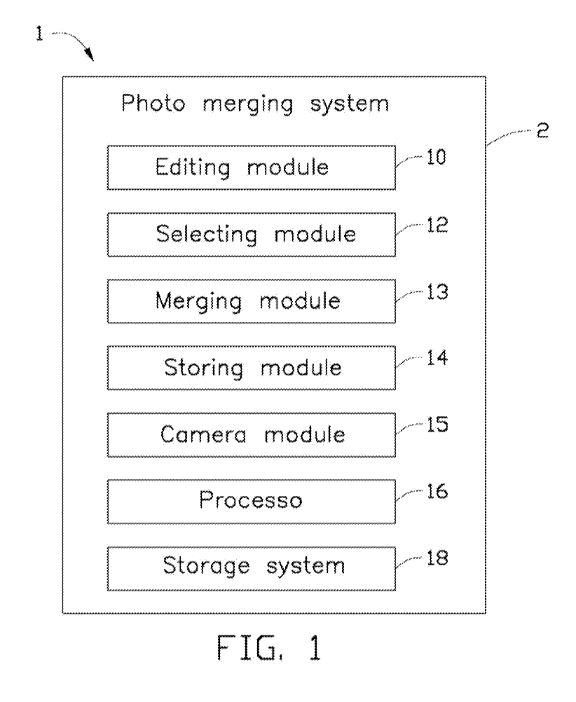

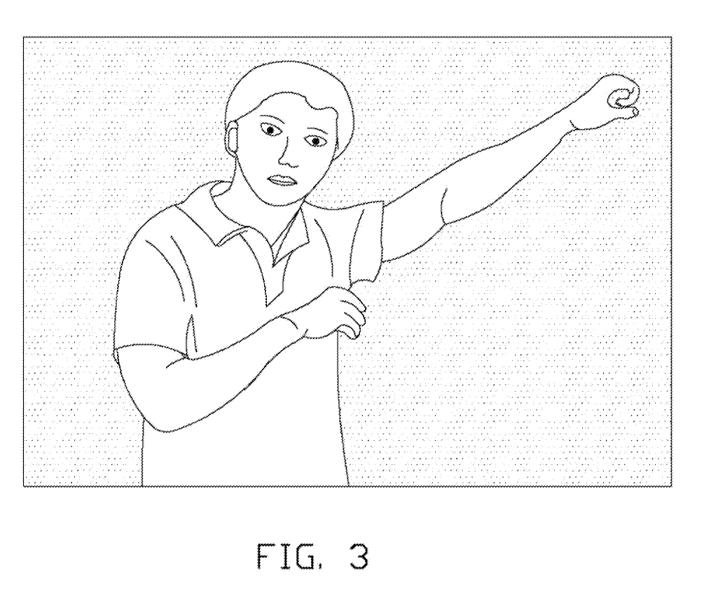

FIG. 1 is a block diagram of one embodiment of an electronic device 1 comprising a camera module 15. The camera module 15 may be used to capture different kinds of photos, such as a portrait photo or scenic photo, for example. One or more portrait photos and/or scenic photos may be merged to form a merged image. It may be understood that a portrait photo is a photograph of person (refer to FIG. 3), whereas a scenic photo is a photograph of some background, such as a building or a sky, for example. The camera module 15 may include at least one charge coupled device (CCD) (not shown) as an image capturing device. In one embodiment, the electronic device 1 may be a mobile phone, a personal digital assistant, or any other device comprising the camera module 15.

The electronic device 1 may include a storage system 18 and a processor 16. The storage system 18 stores one or more programs, such as computerized codes of a photo merging system 2, programs of an operating system, and other applications of the electronic device 1. In one embodiment, the storage system 18 may include a memory of the electronic device 1 (e.g., a hard disk) or an external storage card, e.g., a smart media card, a secure digital card, a compact flash card, or any other type of memory card, for example. The processor 16 executes one or more computerized codes of the photo merging system 2.

In one embodiment, the photo merging system 2 includes an editing module 10, a selecting module 12, a merging module 13, and a storing module 14. Each of the function modules 10-14 may comprise one or more computerized operations that can be executed by the at least one processor 16 of the electronic device 1.

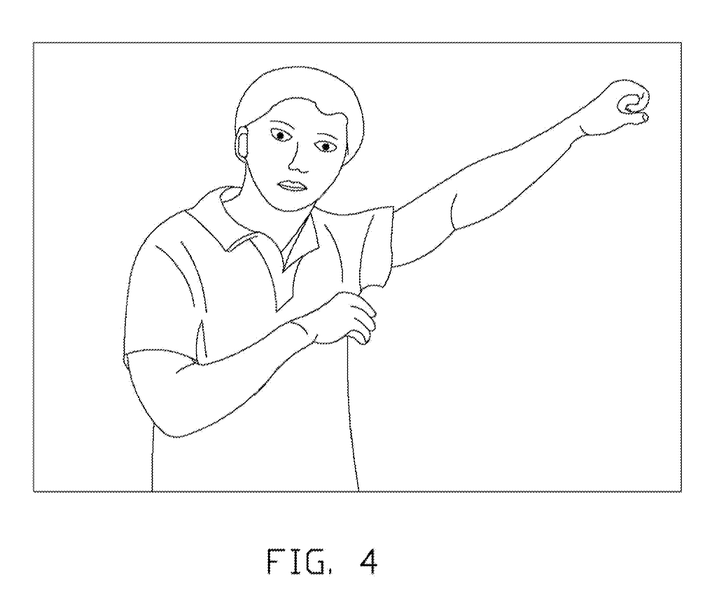

The editing module 10 may be manipulated by a user to select a photo from the storage system 18, and to edit the selected photo to obtain a cropped photo. In one embodiment, the selected photo may be a portrait of a user of the electronic device 1. The photo is edited using a cursor to select a desired portion of the selected photo and cropping the undesired portion to obtain the cropped photo. For example, the user may edit a portrait photo as shown in FIG. 3 using the editing module 10 to obtain a cropped photo as shown in FIG. 4.

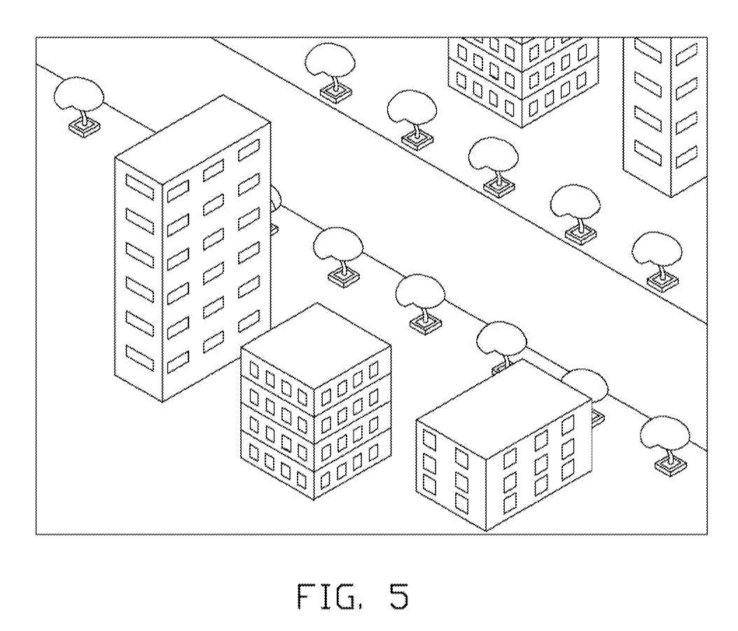

The selecting module 12 selects the cropped photo when the user want to obtain a merged photo. After selecting the cropped photo, the camera module 15 captures a photo, such as a scenic photo as shown in FIG. 5, for example. It may be understood that the user may manipulate the selecting module 12 to select a cropped photo among a plurality of cropped photos.

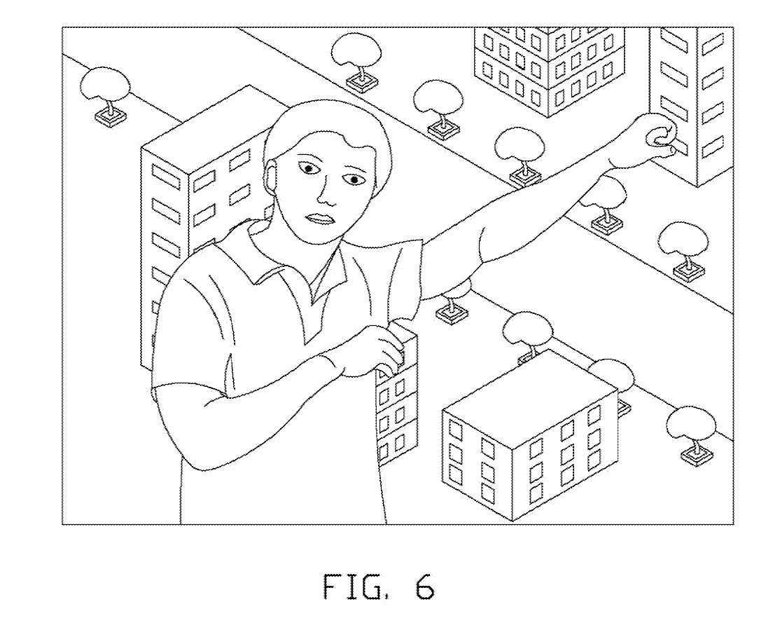

The merging module 13 merges the cropped photo with the captured photo to obtain the merged photo (refer to FIG. 6). The merged photo is obtained by overlapping the captured photo with the cropped photo.

The storing module 14 stores the merged photo in the storage system 18. Then the user may send the merged photo to friends to share the merged photo for entertainment.

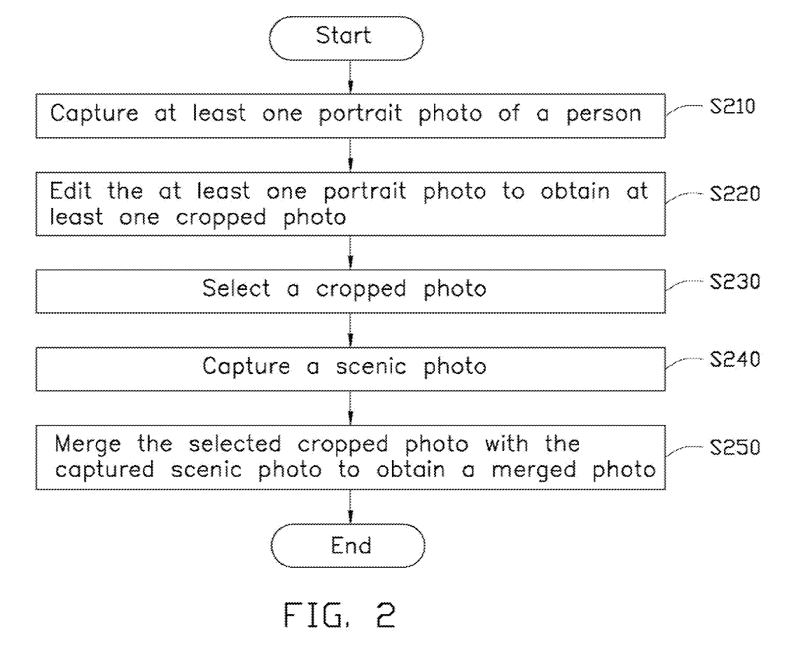

FIG. 2 is a flowchart of one embodiment of a method of merging photos using the electronic device 1. Depending on the embodiment, additional blocks may be added, others removed, and the ordering of the blocks may be changed correspondingly.

In block S210, when the electronic device 1 is powered on, the user captures at least one photo (e.g., a portrait photo) using the camera module 15 of the electronic device 1. As mentioned above, the electronic device 1 may be a mobile phone, a personal digital assistant, or any other device equipped with the camera module 15.

In block S220, the editing module 10 edits the photos to obtain cropped photos. The photos are edited using a cursor to select the desired portions of the photos and cropping the undesired portion to obtain the cropped photos. For example, user may edit the portrait photo as shown in FIG. 3 of a person using the editing module 10 to obtain the cropped photo as shown in FIG. 4.

In block S230, the selecting module 12 selects the cropped photo as shown in FIG. 4 according to users' requirements/demands when the user wants to obtain the merged photo as shown in FIG. 6.

In block S240, the camera module 15 of the electronic device 1 captures a scenic photo as shown in FIG. 5 after selecting the cropped photo.

In block S250, the merging module 13 merges the cropped photo with the captured scenic photo to obtain the merged photo. The merged photo is obtained by overlapping the scenic photo with the cropped photo. The merged photo is stored in the storage system 18 of the electronic device 1.

The user may obtain all kinds of merged photos via the merging method described above. The user may send the obtained merged photos to friends to share the merged photos. Then entertainment value of the electronic device 1 is greatly improved.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A method for merging photos to obtain a merged photo using an electronic device, the electronic device comprising a camera module, the method comprising:
capturing at least one portrait photo using the camera module of the electronic device;
editing the at least one portrait photo to obtain at least one cropped photo;
selecting a cropped photo from the at least one cropped photo;
capturing a scenic photo using the camera module of the electronic device;
merging the selected cropped photo with the captured scenic photo to obtain a merged photo; and
storing the merged photo into a storage system of the electronic device.

2. The method as claimed in claim 1, wherein the at least one portrait photo is edited using a cursor to select the desired portions of the photos and cropping the undesired portion to obtain the cropped photo.

3. The method as claimed in claim 1, wherein the storage system is selected from the group consisting of a smart media card, a secure digital card, and a compact flash card.

4. The method as claimed in claim 1, wherein the electronic device is a mobile phone or a personal digital assistant.

5. An electronic device, the electronic device comprising:
a camera module operable to capture a plurality of portrait photos;
a storage system;
at least one processor; and
one or more programs stored in the storage system and being executable by the at least one processor, the one or more programs comprising:
an editing module operable to edit the at least one portrait photo captured by the camera module of the electronic device to obtain at least one cropped photo;
a selecting module operable to select a cropped photo;
a merging module operable to merge the select cropped photo with a scenic photo captured by the camera module of the electronic device; and
a storing module operable to store the merged photo into the storage system of the electronic device.

6. The electronic device as claimed in claim 5, wherein the at least one portrait photo is edited using a cursor to select the desired portions of the photos and cropping the undesired portion to obtain the cropped photo.

7. The electronic device as claimed in claim 5, wherein the storage system is selected from the group consisting of a smart media card, a secure digital card, and a compact flash card.

8. The electronic device as claimed in claim 5, wherein the electronic device is a mobile phone or a personal digital assistant.

9. A storage medium storing a set of instructions, the set of instructions capable of being executed by a processor to perform a method for merging photos to obtain a merged photo using an electronic device, the electronic device comprising a camera module, the method comprising:
capturing at least one portrait photo using the camera module of the electronic device;
editing the at least one portrait photo to obtain at least one cropped photo;
selecting a cropped photo from the at least one cropped photo;
capturing a scenic photo using the camera module of the electronic device;
merging the selected cropped photo with the captured scenic photo to obtain a merged photo; and
storing the merged photo into a storage system of the electronic device.

10. The storage medium as claimed in claim 9, wherein the at least one portrait photo is edited using a cursor to select the desired portions of the photos and cropping the undesired portion to obtain the cropped photo.

11. The storage medium as claimed in claim 9, wherein the electronic device is a mobile phone or a personal digital assistant.
